(19) United States
(12) Patent Application Publication
(10) Pub. No.: US 2008/0072790 A1
(43) Pub. Date: Mar. 27, 2008

(54) METHODS OF MAKING FINELY STRUCTURED THERMALLY SPRAYED COATINGS

(75) Inventors: Xinqing Ma, Willington, CT (US); Jeffrey Roth, Coventry, CT (US); T. Danny Xiao, Willington, CT (US)

Correspondence Address: CANTOR COLBURN, LLP, 20 Church Street, 22nd Floor, Hartford, CT, 06103, US

(73) Assignee: Inframat Corporation, Farmington, CT (US)

(21) Appl. No.: 11/858,783

(22) Filed: Sep. 20, 2007

Related U.S. Application Data
(60) Provisional application No. 60/826,663, filed on Sep. 22, 2006.

(51) Int. Cl. C09D 1/00; B05D 1/08; C23C 4/00; C23C 4/08; C23C 4/10; C23C 4/06; B05D 1/36

(52) U.S. Cl. 106/286.3; 106/286.1; 106/286.4; 106/286.5; 427/446; 427/450; 427/451; 427/453; 427/454; 427/455; 427/456

(57) ABSTRACT

Methods of making a metallic or cerment coating include suspending solid fine metal or cerment particles in a liquid to form a liquid feedstock and injecting the liquid feedstock into an high-velocity oxygen fuel flame gun to thermally spray the liquid feedstock on a substrate to form a coating thereon.

### CROSS REFERENCE TO RELATED APPLICATION

This application claims the benefit of U.S. Provisional Patent Application No. 60/826,663 filed Sep. 22, 2006, which is incorporated by reference herein in its entirety.

### TECHNICAL FIELD

The present disclosure generally relates to coatings, and more specifically to methods of making finely structured metallic and cermet (ceramic-metal composite) coatings via high-velocity oxygen fuel thermal spraying.

### BACKGROUND

A wide variety of protective coatings are used in industry for corrosion, erosion, and wear resistance of components in machinery such as water boilers, turbine engines, pipe systems, and the like. In the case of water boilers, high pressures, thermal loads, gradual wall thinning induced by high temperature oxidation, hot corrosion, sulfidation, erosion, and overheating can limit the lifetimes of such components. Surface modification and coating techniques have proven to be effective methods to reduce damage and degradation to components and thus prevent the failure thereof.

Some of the types of coatings and processes commercially available include weld overlay deposits, thermal spray coatings, and chromized or aluminized coatings. The weld overlay method is capable of efficiently depositing thick-layered coatings that are easily repaired. Moreover, on-site welding can be performed. However, microsegregation, preferential corrosion, circumferential cracking, induced residual stress, tube warping, and the formation of a brittle fusion line interface are all problems commonly associated with coatings applied by this method.

Thermal spray techniques, including arc spray, plasma spray, high velocity oxygen fuel (HVOF) spray, detonation spray, and the like, have been employed to apply a wide range of coating materials to substrate surfaces. For example, thermal spraying has been used to form stainless steel, alloy, intermetallic, and carbide cermet coatings on component substrate surfaces. Coatings formed by thermal spraying can provide for corrosion resistance, wear and erosion resistance, high temperature oxidation resistance, and hot corrosion resistance in, for example, power plant and turbine engine machinery. However, in some cases, thermally sprayed coatings can include defective microstructures and a lack of metallurgical bonding to the substrate. Consequently, these coatings can be susceptible to degradation and can exhibit a high risk of flaking after exposure to corrosion, oxidation, erosion, and/or extreme thermal conditions.

Amongst the thermal spray techniques, HVOF provides the highest coating-to-substrate bond strength as well as the highest coating density. However, due to the relatively low flame temperature and short particle resident time in the flame, HVOF coatings can include a significant amount of unmelted and partially melted particles. The presence of such particles in a HVOF coating can adversely affect the coating uniformity, density, adhesion, and cohesion, and the physical or mechanical properties of the coating. Improved HVOF coating properties can be obtained by treating the coating in a supplementary process, such as laser melting but this additional process increases costs and can lead to thermal stress-induced coating damage.

An alternative way for increasing the melting in HVOF coatings is to use smaller powder feedstocks. In the HVOF process, powder feedstocks have been introduced to the thermal spray flame using gas as the carrier of the feedstocks. Fine powder feedstocks, however, are very difficult to supply at a constant feed rate when gas is used as the carrier, particularly when their sizes are below 10 micrometers (μm).

Three main types of thermal spraying feedstocks have been employed. The first of these is a powder feedstock comprising solid particles ranging in size from about 20 μm to about 120 μm, which are carried by a gas. The second type of feedstock is a slurry comprising solid particles. The third type of feedstock is a liquid solution having no solid-state phase in which coatings are formed by thermal decomposition or reaction, e.g., by pyrolysis.

### BRIEF SUMMARY

Disclosed herein are methods of making finely structured metallic or cermet coatings. In one embodiment, a method of making a metallic or cermet coating includes suspending solid fine metal or cermet particles in a liquid to form a liquid feedstock; and injecting the liquid feedstock into a high-velocity oxygen fuel flame gun to thermally spray the liquid feedstock on a substrate to form a coating thereon.

In another embodiment, a method of making a multi-layered coating includes providing first and second feedstocks, wherein at least one of the first and second feedstocks comprises solid fine metal or cermet particles suspended in a liquid; and sequentially injecting the first and second feedstocks into a high-velocity oxygen fuel flame gun to thermally spray the feedstocks on the substrate, thereby forming first and second layers stacked on the substrate.

Other embodiments include coatings made by the above methods.

Still other embodiments include articles comprising the above coatings.

The above described and other features are exemplified by the following detailed description and figures.

### BRIEF DESCRIPTION OF THE DRAWINGS

Referring now to the figures, which are exemplary embodiments and wherein like elements are numbered alike:

FIG. 1 schematically illustrates a thermal spraying system for making finely structured metallic or cermet coatings using a high-velocity oxygen fuel (HVOF) flame gun;

FIG. 2 depicts scanning electron microscopy (SEM) micrographs showing (a) a coating formed using a prior art HVOF spray feedstock and (b) a coating formed using the HVOF feedstock disclosed herein;

FIG. 3 depicts scanning electron microscopy (SEM) micrographs showing (a) a coating formed using a prior art HVOF spray feedstock and (b) a coating formed using the HVOF feedstock disclosed herein;

FIG. 4 graphically illustrates the feedstock temperature as a function of the HVOF spray distance for various HVOF feedstocks.

FIG. 5 graphically illustrates the feedstock velocity as a function of the HVOF spray distance for various HVOF feedstocks; and

FIG. 6 schematically illustrates a thermal spraying system for making finely structured metallic or cermet coatings using a HVOF flame gun.

### DETAILED DESCRIPTION

Disclosed herein are methods of making finely structured coatings using liquid feedstocks comprising metal or cermet solid fine particles suspended in the liquid. The coatings produced by these methods have relatively high densities, uniform microstructures, high bond strengths, and high deposition efficiencies. Using a liquid carrier rather than a gas carrier allows the fine particles to be supplied to the high-velocity oxygen fuel (HVOF) flame at a relatively constant rate. As such, fine particles having smaller dimensions than those previously used in thermal spraying feedstocks can be fed to the HVOF flame to ensure that most of the particles become partially or fully melted by the flame.

As used herein, the term “liquid” is intended to encompass suspensions, colloids, and the like. Also, the term “fine particles” refers to particles having an average longest grain dimension of less than about 10 μm, more specifically less than about 1 μm, and even more specifically less than about 100 nanometers (nm). Thus, the term “finely structured” refers to a material comprising fine particles. Additionally, the term “cermet” refers to a ceramic-metal composite.

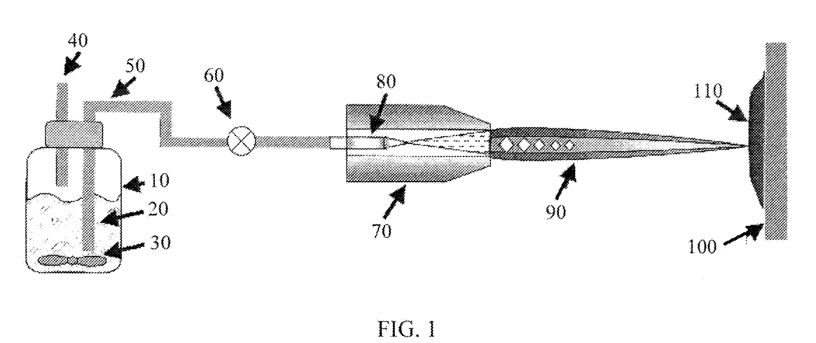

Referring now to FIG. 1, an exemplary embodiment of a system for making a finely structured metal or cermet coating is shown. A high-pressure tank 10 holds a liquid feedstock 20 comprising solid fine metal or cerment particles suspended in a liquid mixture. A stirrer 30 can be used to constantly stir the liquid mixture, thus keeping the particles in a state of suspension. A gas inlet 40 can be used to pressurize the tank 10 to a pressure of, e.g., about 80 to about 180 pounds per square inch (psi). The gas supplied to the tank 10 can be, for example, air, nitrogen, argon, or mixtures thereof. The liquid feedstock 20 can be delivered under tank pressure to an adjustable valve or a mass flow controller 60 via a conduit 50. The adjustable valve/mass flow controller 60 can be used to control the liquid feedstock flow rate.

A HVOF flame gun 70 located downstream from the tank 10 can be equipped with a liquid injector 80 that feeds the liquid feedstock 20 into the combustion chamber of the HVOF flame gun 70 and eventually into the HVOF flame 90. The liquid feedstock 20 can be supplied to the flame 90 either in a co-axial direction or a radial direction, wherein the co-axial direction is parallel to an axis of the gun and the radial direction is parallel to a radius of the flame. The fuel used in the HVOF flame gun 70 can be, for example, propylene, hydrogen, or kerosene. The fine particles can be at least partially melted and propelled by the flame 90 to the surface of a substrate 100, such as a workpiece. HVOF parameters such as fuel-to-oxygen ratio, flow rate, and spray distance can be optimized based on coating microstructure analyses and process diagnostic methods. As a result of the particles impacting the surface of the substrate 100, a coating 110 can be deposited on that surface that exhibits a high degree of melting, a fine splat size, a fine grain size, a high density, and a high bond strength to the underlying surface.

Examples of suitable liquids for use in the liquid feedstock include but are not limited to water, organic liquids such as ethanol, acetone, glycerol, and kerosene, solutions comprising inorganic and/or organic metal salt precursors, and combinations comprising at least one of the foregoing. In embodiments in which the liquid feedstock is an organic liquid, an exothermal effect can occur in the HVOF flame, causing the particles to experience a high degree of melting and the coating deposited on the substrate surface to have a very high bond strength. In other embodiments in which the liquid feedstock is a solution comprising inorganic and/or organic metal salts, such salts can be thermally converted into metal and/or ceramic particles via chemical reactions such as pyrolysis, oxidation, and/or reduction reactions. As a result, a composite coating having good chemical homogeneity and a relatively uniform microstructure, i.e., finely structured, can be formed.

Examples of suitable metal and ceramic materials for use in the fine metal or cerment particles of the feedstock include but are not limited to aluminum (Al), transition metals such as cobalt (Co), nickel (Ni), iron (Fe), molybdenum (Mo), and chromium (Cr), alloys of such metals including Ni-based alloys such as Co—Ni and Fe—Cr based alloys, metal oxides such as alumina (Al₂O₃), chromia (Cr₂O₃), zirconia (ZrO₂), titania (TiO₂), and ceria (CeO₂), carbides such as tungsten carbide (WC), titanium carbide (TiC), vanadium carbide (VC), chromium carbide (Cr₃C₂), tantalum carbide (TaC), and silicon carbide (SiC), nitrides such as aluminum nitride (AlN), silicon nitride (Si₃N₄), and zirconium nitride (ZrN), and borides such as titanium diboride (TiB₂) and zirconium boride, and combinations comprising at least one of the foregoing materials.

The amount of particles present in the liquid feedstock can range from about 5 weight % (wt. %) to about 80 wt. %, specifically about 20 wt. % to about 60 wt. %, more specifically about 30 wt. % to about 60 wt. %, and even more specifically about 30 wt. % to about 50 wt. %, wherein all weight percentages are based on the total weight of the liquid feedstock.

Currently used surface preparation procedures can be applied to the substrate 100 prior to the HVOF spraying. For example, the substrate 100 can be subjected to degreasing and coarsening by sand gritting to ensure that the ensuing coating adheres to it well.

In one exemplary embodiment, the liquid feedstock is prepared by gradually adding metal or cermet fine particles to the pre-selected liquid and mechanically mixing the suspended solution that is formed. A wetting agent also can be added to the liquid feedstock to de-agglomerate the particles and maintain a thorough suspension. Examples of suitable wetting agents include but are not limited to polyvinyl alcohol, ammonium polymethacrylate, sodium methacrylate, sodium sulfamate, and combinations comprising at least one of the foregoing wetting agents. During the HVOF spray process, the liquid mixture can be continuously stirred. When the liquid feedstock is fed to the HVOF flame gun, the liquid evaporates and the fine particles at least partially melt before impacting the substrate to form a deposit coating.

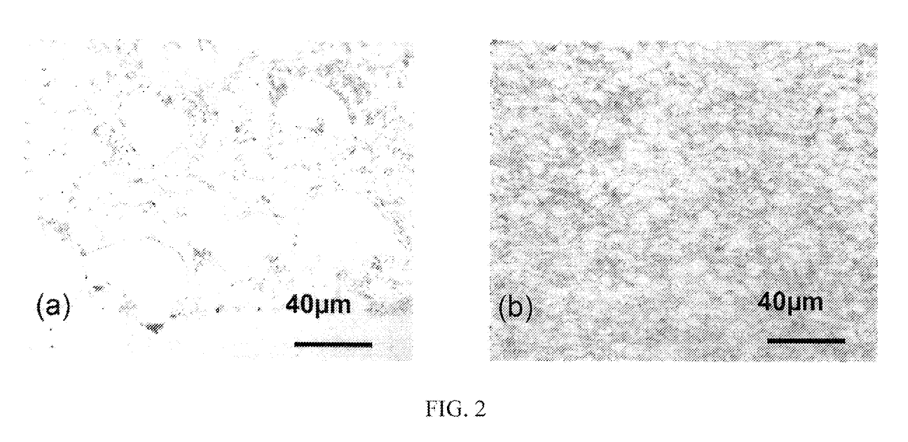

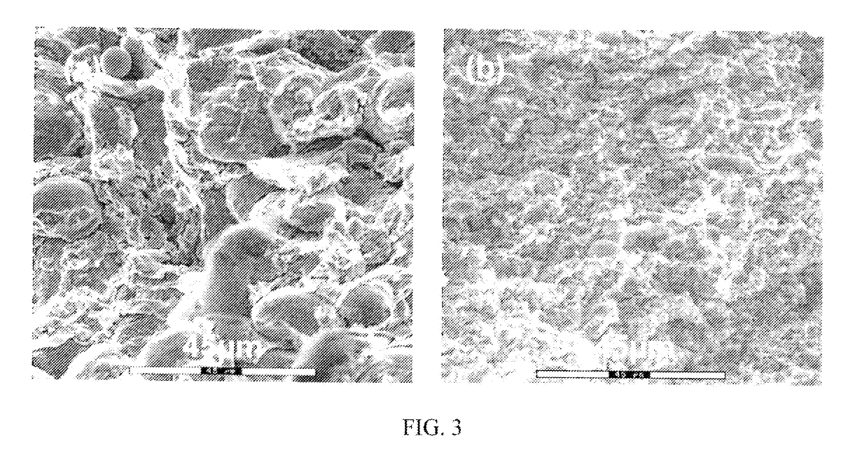

Compared to the coating formed in a current HVOF process, the coating formed in the liquid feedstock-HVOF (LF-HVOF) process described herein has much finer microstructure features, as illustrated in FIG. 2. In particular, FIG. 2(a) depicts a SEM micrograph of a coating formed using a current HVOF process, and FIG. 2(b) depicts a SEM micrograph of a coating formed using a LF-HVOF process in which the liquid feedstock includes an organic liquid. The coating of FIG. 2(b) exhibits finer and more uniform splats compared to that of FIG. 2(a), which are attributed to the use of smaller-sized particles in the feedstock. FIGS. 3 (a) and (b) further depict fractured morphologies of the coatings shown in FIGS. 2 (a) and (b). As shown, the coating formed using the current HVOF process includes many more spherical particles than the coating formed using the new LF-HVOF process, indicating a lower degree of feedstock melting. In particular, the percentage of area occupied by the unmelted spheres in the coating of FIG. 3(a) as opposed to well-melted spheres is at least 40%. In contrast, the LF-HVOF coating of FIG. 3(b) includes an even and dense microstructure and comprises much less spherical particles, indicating a higher degree of feedstock melting. This observation is consistent with the surface roughness of the coatings. In particular, a LF-HVOF coating can have a roughness average (Ra) of about 2.5 μm, whereas current HVOF coatings can have a Ra of about 8.3 μm. A LF-HVOF coating also exhibits increased ductility and bond strength as compared to current HVOF coatings.

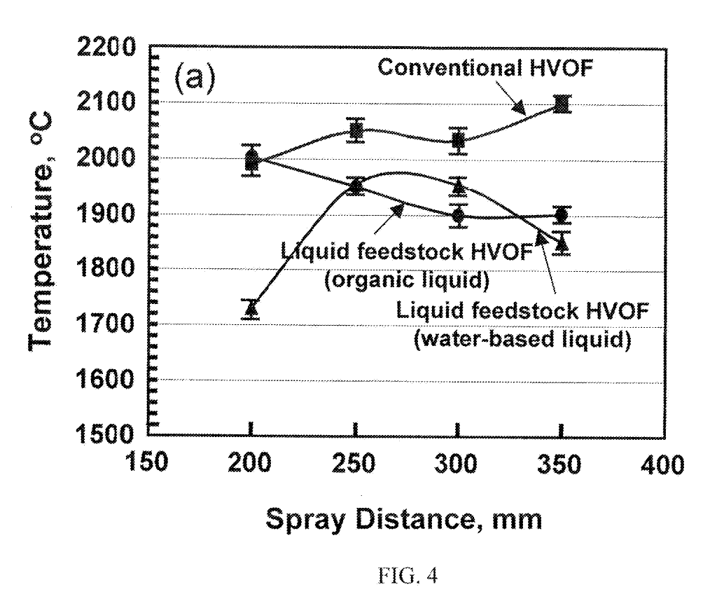

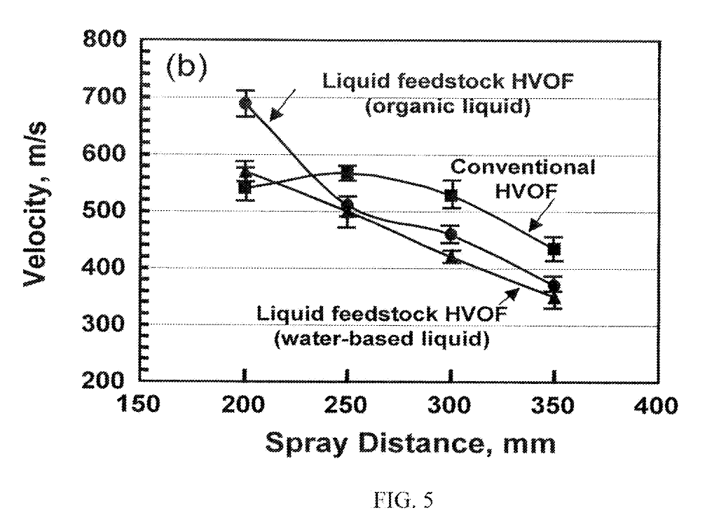

FIGS. 4 and 5 further compare the dependency of the flame temperature and the flame velocity, respectively, on the spray distance for an existing HVOF process, a LF-HVOF process using organic liquid in the feedstock, and a LF-HVOF process using a water-based liquid in the feedstock. Due to the exothermal nature of the organic liquid, the particles of the organic liquid containing feedstock melted to a higher degree than the particles of the other feedstocks. Thus, its spray temperature advantageously decreased as the spray distance increased to 300 millimeters (mm) and then leveled off. These figures indicate that under certain spray conditions, the LF-HVOF process can be optimized for higher particle velocity and temperature than can current HVOF processes. As a result, the LF-HVOF has improved coating density, bond strength, and deposition rate.

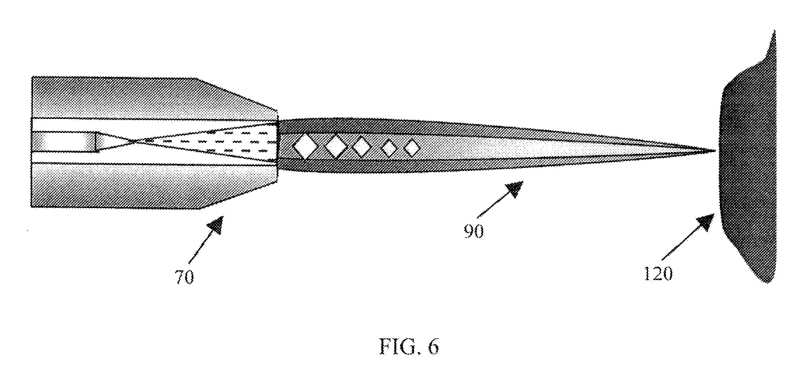

In accordance with another embodiment, a multi-layered coating or a graded compositional coating, i.e., a preform, can be formed by sequentially injecting different compositional feedstocks into the HVOF flame gun. At least one of the feedstocks comprises metal or cermet solid fine particles suspended in a liquid. For example, two or more metallic or cermet layers can be deposited on a substrate by sequentially spraying multiple liquid feedstocks comprising metal or cermet solid fine particles suspended in a liquid. Alternatively, two or more layers can be deposited on a substrate by sequentially spraying very different feedstocks, wherein one of the feedstocks comprises metal or cermet solid fine particles suspended in a liquid and another of the feedstocks comprises solid particles and a flowable fluid with no suspension in a liquid (i.e., a prior art feedstock). FIG. 6 illustrates the formation of a preform 120 using the LF-HVOF spraying process described herein. Multiple pressurized tanks and delivery devices can be used for the different feedstocks.

The LF-HVOF thermal spraying process described herein advantageously forms finely structured coatings having a higher density, more uniform microstructure, and higher bond strength relative to those coatings formed in current HVOF processes. The finely structured coatings also have superior coating integrity, surface quality, and ductility. These property improvements are a result of better melting and higher velocity of the solid fine particles in the LF-HVOF process.

Due to their relatively high corrosion resistance, wear resistance, and abrasion resistance, the finely structured coatings can be applied to components utilized in industries such as the automotives, aerospace, petrochemical, electric power, and chemical industries. They also can be used in their multi-layered forms for various applications such as in catalysts and electronic devices and for high temperature applications. As such, these coatings can be present in various end use articles such as automotive parts, boilers, superheaters, gas turbines, blades, vanes, gears, bearings, valves, pistons, pipes, and the like.

The invention is further illustrated by the following non-limiting examples.

### EXAMPLE 1

In this example, INCONEL® 625 fine particles comprising nickel-chromium-molybdenum alloy and having a fine particle size of less than about 11 μm was used in the liquid feedstock. About 250 grams (g) of the particles were added to about 1 liter of water and continuously agitated. A wetting agent was then added to the resultant suspension. The suspension was continuously stirred for at least about 5 hours before its use. The liquid tank was pressurized to at least about 80 psi to deliver the suspension to the liquid nozzle. A HVOF system (Diamond Jet 2700 sold by Sulzer-Metco) was employed to thermally spray a coating on a carbon steel substrate. The substrate was preheated to a temperature above about 80° C. The resultant coating had a density of more than 99% and an average thickness of about 150 to about 250 millimeters (mm). The LF-HVOF process parameters for the coating are given below:

Fuel: propylene—194 standard cubic foot per hour (scfh) at 100 psi

Oxygen: 347 scfh at 150 psi

Air: 876 scfh at 105 psi

Standoff distance: 8 inches

Gun speed: traverse speed—1000 millimeters per second (mm/s); vertical

speed—8 mm/s

Feed rate: 20 to 30 grams per minute (g/min)

### EXAMPLE 2

In this example, INCONEL® 625 fine particles were used in the liquid feedstock. About 200 g of the particles were added to about 1 liter of ethanol and continuously agitated. A wetting agent was then added to the resultant suspension. The suspension was continuously stirred for at least about 5 hours before its use. The liquid tank was pressurized to at least about 80 psi to deliver the suspension to the liquid nozzle. A Diamond Jet 2700 HVOF system was employed to thermally spray a coating on a carbon steel substrate. The substrate was preheated to a temperature above about 80° C. The resultant coating had a density of more than 99% and an average thickness of about 150 to about 250 mm. The LF-HVOF process parameters for the coating are given below:

Fuel: propylene, 194 scfh/100 psi

Oxygen: 347 scfh/150 psi

Air: 876 scfh/105 psi

Standoff distance: 9 inches

Gun speed: traverse speed—1000 mm/s; vertical speed—8 mm/s

Feed rate: 20 to 30 g/min

### EXAMPLE 3

In this example, INCONEL® 625 fine particles were used in the liquid feedstock. About 200 g of the powder were added to a mixture of about 0.5 liters of water and about 0.5 liters of glycerol and continuously agitated. A wetting agent was then added to the resultant suspension. The suspension was continuously stirred for at least about 5 hours before its use. The liquid tank was pressurized to at least about 80 psi to deliver the suspension to the liquid nozzle. A Diamond Jet 2700 HVOF system was employed to thermally spray a coating on a carbon steel substrate. The substrate was preheated to a temperature above about 80° C. The resultant coating had a density of more than 99% and an average thickness of about 150 to about 250 mm. The LF-HVOF process parameters for the coating are given below:

Fuel: propylene, 194 scfh/100 psi

Oxygen: 347 scfh/150 psi

Air: 876 scfh/105 psi

Standoff distance: 8 inches

Gun speed: traverse speed—1000 mm/s; vertical speed—8 mm/s

Feed rate: 20 to 30 g/min

### EXAMPLE 4

In this example, a LF-HVOF process was used to thermally spray INCONEL® 625 fine particles onto an aluminum bond-coat. First, an aluminum layer having a thickness of about 20 to about 50 μm was HVOF sprayed onto a steel substrate. A top layer of INCONEL® 625 alloy was then sprayed onto the aluminum bond-coat using the LF-HVOF process as described in Example 1 above. The resultant top coat layer had a density of more than 99%, a thickness of about 150 to about 250 mm, and was highly bonded to the aluminum bond-coat. The HVOF process parameters for the aluminum layer are given below:

Fuel: propylene, 176 scfh/100 psi

Oxygen: 389 scfh/150 psi

Air: 1058 scfh/105 psi

Standoff distance: 10 inches

Gun speed: traverse speed—1000 mm/s; vertical speed—8 mm/s

Powder feed rate: 2 to 3 pounds per hour (lbs/h)

### EXAMPLE 5

In this example, a LF-HVOF process was used to thermally spray INCONEL® 625 fine particles onto a self-flux alloy bond-coat. A self-flux NiCrSiB alloy layer of about 20 to about 50 μm was HVOF sprayed onto a steel substrate. A top layer of INCONEL® 625 alloy was then sprayed onto the self-flux alloy bond-coat using the LF-HVOF process as described in Example 1 above. The resultant top coat layer had a density of more than 99%, a thickness of about 150 to about 250 mm, and was highly bonded to the NiCrSiB bond-coat. The HVOF process parameters for the self-flux layer are given below:

Fuel: propylene, 176 scfh/1100 psi

Oxygen: 289 scfh/150 psi

Air: 1058 scfh/105 psi

Standoff distance: 10 inches

Gun speed: traverse speed, 1000 mm/s; vertical speed, 8 mm/s

Powder feed rate: 2 to 3 lbs/h

### EXAMPLE 6

In this example, INCONEL® 625 fine particles were used in the liquid feedstock. About 50 g of the powder were added to a 1 liter precursor liquid mixture comprising 7 weight % yttria stabilized zirconia based on the total weight of the liquid mixture while continuously agitating the mixture. A wetting agent was then added to the resultant suspension. The suspension was continuously stirred for at least about 5 hours before its use. The liquid tank was pressurized to at least about 80 psi to deliver the suspension to the liquid nozzle. A Diamond Jet 2700 HVOF system was employed to thermally spray a coating on a carbon steel substrate. The substrate was preheated to a temperature above about 80° C. The resultant coating had a density of more than 99% and an average thickness of about 20 to about 50 μm. The LF-HVOF process parameters for the coating are given below:

Fuel: propylene, 194 scfh/100 psi

Oxygen: 347 scfh/150 psi

Air: 876 scfh/105 psi

Standoff distance: 8 inches

Gun speed: traverse speed, 1000 mm/s; vertical speed, 8 mm/s

Feed rate: 20 to 30 g/min

### EXAMPLE 7

In this example, Fe-20Cr alloy powder having a fine particle size of less than about 11 μm was used in the liquid feedstock. About 200 g of the powder were added to about 1 liter of water and continuously agitated. A wetting agent was then added to the resultant suspension. The suspension was continuously stirred for at least about 5 hours before its use. The liquid tank was pressurized to at least about 80 psi to deliver the suspension to the liquid nozzle. A Diamond Jet 2700 HVOF system was employed to thermally spray a coating on a carbon steel substrate. The substrate was preheated to a temperature above about 80° C. The resultant coating had a density of more than 99% and an average thickness of about 150 to about 250 μm. The HVOF process parameters for the coating are given below:

Fuel: propylene, 194 scfh/100 psi

Oxygen: 347 scfh/150 psi

Air: 876 scfh/105 psi

Standoff distance: 8 inches

Gun speed: traverse speed—1000 mm/s; vertical speed—8 mm/s

Feed rate: 20 to 30 g/min

### EXAMPLE 8

In this example, Fe-20Cr alloy powder having a fine particle size of less than about 11 μm was used in the liquid feedstock. About 200 g of the powder were added to about 1 liter of ethanol and continuously agitated. A wetting agent was then added to the resultant suspension. The suspension was continuously stirred for at least about 5 hours before its use. The liquid tank was pressurized to at least 80 psi to deliver the suspension to the liquid nozzle. A Diamond Jet 2700 HVOF system was employed to thermally spray a coating on a carbon steel substrate. The substrate was preheated to a temperature above about 80° C. The resultant coating had a density of more than 99% and an average thickness of about 150 to about 50 μm. The HVOF process parameters for the coating are given below:

Fuel: propylene, 194 scfh/100 psi

Oxygen: 347 scfh/150 psi

Air: 876 scfh/105 psi

Standoff distance: 8 inches

Gun speed: traverse speed—1000 mm/s; vertical speed—8 mm/s

Feed rate: 20 to 30 g/min

As used herein, the terms “a” and “an” do not denote a limitation of quantity, but rather denote the presence of at least one of the referenced items. Moreover, the endpoints of all ranges directed to the same component or property are inclusive of the endpoint and independently combinable (e.g., “about 5 wt. % to about 20 wt. %,” is inclusive of the endpoints and all intermediate values of the ranges of about 5 wt. % to about 20 wt. %). Reference throughout the specification to “one embodiment”, “another embodiment”, “an embodiment”, and so forth means that a particular element (e.g., feature, structure, and/or characteristic) described in connection with the embodiment is included in at least one embodiment described herein, and might or might not be present in other embodiments. In addition, it is to be understood that the described elements may be combined in any suitable manner in the various embodiments. Unless defined otherwise, technical and scientific terms used herein have the same meaning as is commonly understood by one of skill in the art to which this invention belongs.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A method of making a metallic or cermet coating, comprising:
suspending solid fine metal or cermet particles in a liquid to form a liquid feedstock; and
injecting the liquid feedstock into a high-velocity oxygen fuel flame gun to thermally spray the liquid feedstock on a substrate to form a coating thereon.

2. The method of claim 1, further comprising stirring the liquid feedstock to keep the solid fine particles suspended in the liquid prior to said injecting the liquid feedstock.

3. The method of claim 1, wherein the solid fine particles comprise aluminum, transition metals, cobalt, nickel, iron, molybdenum, and chromium, alloys comprising at least one of the foregoing metals, a cobalt-nickel alloy, an iron-chromium alloy, alumina, chromia, zirconia, ceria, titania, tungsten carbide, titanium carbide, vanadium carbide, chromium carbide, tantalum carbide, silicon carbide, aluminum nitride, silicon nitride, zirconium nitride, titanium diboride, zirconium boride, or a combination comprising at least one of the foregoing materials.

3. The method of claim 1, wherein the liquid comprises water, an organic liquid, ethanol, acetone, glycerol, kerosene, an inorganic salt, an organic salt, or a combination comprising at least one of the foregoing.

4. The method of claim 1, wherein the solid fine particles have an average longest grain dimension of less than about 10 micrometers, less than about 1 micrometer, or less than about 100 nanometers.

5. The method of claim 1, wherein said injecting the liquid feedstock comprises co-axially injecting the liquid feedstock into the high-velocity oxygen fuel flame gun.

6. The method of claim 1, wherein said injecting the liquid feedstock comprises radially injecting the liquid feedstock into the high-velocity oxygen fuel flame gun.

7. The method of claim 1, further comprising annealing the coating.

8. The method of claim 1, further comprising preheating the substrate.

9. A method of making a multi-layered coating, comprising:
providing first and second feedstocks, wherein at least one of the feedstocks comprises solid fine metal or cermet particles suspended in a liquid; and
sequentially injecting the first and second feedstocks into a high-velocity oxygen fuel flame gun to thermally spray the feedstocks on the substrate, thereby forming first and second layers stacked on the substrate.

10. The method of claim 9, wherein one of the feedstocks comprises solid fine metal or cermet particles suspended in a liquid, and wherein another of the feedstocks comprises solid particles and a flowable fluid.

11. The method of claim 9, wherein the first and second feedstocks both comprise solid fine metal or cermet particles suspended in a liquid.

12. The method of claim 9, further comprising stirring the at least one of the feedstocks to keep the solid fine particles suspended in the liquid prior to said sequentially injecting the feedstocks.

13. The method of claim 9, wherein the solid fine particles comprise aluminum, transition metals, cobalt, nickel, iron, molybdenum, and chromium, alloys comprising at least one of the foregoing metals, a cobalt-nickel alloy, an iron-chromium alloy, alumina, chromia, zirconia, ceria, titania, tungsten carbide, titanium carbide, vanadium carbide, chromium carbide, tantalum carbide, silicon carbide, aluminum nitride, silicon nitride, zirconium nitride, titanium diboride, zirconium boride, or a combination comprising at least one of the foregoing materials.

14. The method of claim 9, wherein the liquid comprises water, an organic liquid, ethanol, acetone, glycerol, kerosene, an inorganic salt, an organic salt, or a combination comprising at least one of the foregoing.

15. The method of claim 9, wherein the solid fine particles have an average longest grain dimension of less than about 10 micrometers, less than about 1 micrometer, or less than about 100 nanometers.

16. The method of claim 9, wherein said sequentially injecting the feedstocks comprises co-axially injecting the feedstocks into the high-velocity oxygen fuel flame gun.

17. The method of claim 9, wherein said sequentially injecting the feedstocks comprises radially injecting the feedstocks into the high-velocity oxygen fuel flame gun.

18. The method of claim 9, further comprising annealing the coating.

19. The method of claim 9, further comprising preheating the substrate.

20. A coating made by the method of claim 1

21. A multi-layered coating made by the method of claim 9.

22. An article comprising the coating of claim 20.

23. An article comprising the multi-layered coating of claim 21.
